(19) United States
(12) Patent Application Publication
(10) Pub. No.: US 2026/0362393 A1
(43) Pub. Date: Nov. 12, 2026

(54) RAN CONTROLLED PAGING

(71) Applicant: InterDigital Patent Holdings, Inc., Wilmington, DE (US)

(72) Inventors: Taimoor Abbas, Sainte-Julie (CA); Samir Ferdi, Kirkland (CA); Michael Starsinic, Newtown, PA (US); Ulises Olvera-Hernandez, Saint-Lazare (CA); Anuj Sethi, Ottawa (CA); Saad Ahmad, Montreal (CA); Jung Je Son, Warrington, PA (US); Achref Methenni, Montreal (CA); Michel Roy, Candiac (CA)

(73) Assignee: InterDigital Patent Holdings, Inc., Wilmington, DE (US)

(21) Appl. No.: 19/202,971

(22) Filed: May 8, 2025

(51) Int. Cl. H04W 68/02; H04L 41/14; H04W 60/04; H04W 64/00

(52) U.S. Cl. CPC H04W 68/02; H04L 41/14; H04W 60/04; H04W 64/00

(57) ABSTRACT

Systems, methods, and devices for wireless communication. A request is sent for wireless transmit/receive unit (WTRU) context information, to a user equipment context function (UCF), responsive to an indication that paging is required. The WTRU context information is received from the UCF in response to the request. A downlink (DL) protocol data unit (PDU) is sent to a radio access network (RAN) node based on the WTRU context information. In some implementations, the network device implements a user plane function (UPF), and the indication that paging is required comprises downlink data. In some implementations, the indication that paging is required comprises downlink data received for a PDU session with a WTRU that is in an idle mode or an inactive mode.

### BACKGROUND

Current 5G networks include duplicated paging-related functionalities, e.g., due to AMF serving as a single termination point for non-access stratum (NAS) signaling between wireless transmit/receive units (WTRU) and the 5G core. Accordingly, it may be desired to provide systems, methods, and devices which overcome these deficiencies.

### SUMMARY

Systems, methods, and devices for wireless communication. In some implementations, a request is sent for wireless transmit/receive unit (WTRU) context information, to a user equipment context function (UCF), responsive to an indication that paging is required. The WTRU context information is received from the UCF in response to the request. A downlink (DL) protocol data unit (PDU) is sent to a radio access network (RAN) node based on the WTRU context information. In some implementations, the network device implements a user plane function (UPF), and the indication that paging is required comprises downlink data. In some implementations, the indication that paging is required comprises downlink data received for a PDU session with a WTRU that is in an idle mode or an inactive mode. In some implementations, the network device implements a location management function (LMF) or a network data analytics function (NWDAF), and the indication that paging is required comprises a requirement for an updated location of the WTRU or a requirement that new data be collected from the WTRU.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a block diagram which illustrates a simplified version of a 5G System Architecture;

FIG. 3 is a block diagram which shows an example control plane stack;

FIG. 4 is a block diagram which illustrates a simplified version of an example Next Generation network architecture;

FIG. 5 is a message sequence chart showing a procedure which illustrates example RAN controlled paging;

FIG. 6 is a message sequence chart showing a procedure 600 which illustrates another example of RAN controlled paging; and

FIG. 7 is a flow chart illustrating an example method for RAN controlled paging.

### DETAILED DESCRIPTION

Some implementations provide a method implemented in a network device. a request is sent for wireless transmit/receive unit (WTRU) context information, to a user equipment context function (UCF), responsive to an indication that paging is required. The WTRU context information is received from the UCF in response to the request. A downlink (DL) protocol data unit (PDU) is sent to a radio access network (RAN) node based on the WTRU context information. In some implementations, the network device implements a user plane function (UPF), and the indication that paging is required comprises downlink data. In some implementations, the indication that paging is required comprises downlink data received for a PDU session with a WTRU that is in an idle mode or an inactive mode. In some implementations, the network device implements a location management function (LMF) or a network data analytics function (NWDAF), and the indication that paging is required comprises a requirement for an updated location of the WTRU or a requirement that new data be collected from the WTRU.

In some implementations, the request for WTRU context information indicates a cause for the request for WTRU context information, a WTRU identifier, and/or a session identifier. In some implementations, the WTRU context information indicates likely WTRU locations in order from most likely location to least likely location. In some implementations, the WTRU context information indicates WTRU identifier information, connected mode (CM) state information, registration mode (RM) state information, WTRU registration area information, WTRU most recent location information, WTRU most likely location information, RAN node identifier information, paging timing information, WTRU radio capability information, and/or paging restriction information. Some implementations also include triggering the RAN node to initiate paging based on the context information prior to sending a DL PDU to a RAN node. In some implementations, the network device implements a network function. In some implementations, the network function comprises a user plane function (UPF), short message service function (SMSF), location management function (LMF), and/or artificial intelligence/machine learning function (AIML).

Some implementations provide a network device. The network device includes circuitry configured to send a request for WTRU context information to a UCF, responsive to an indication that paging is required. The network device also includes circuitry configured to receive the WTRU context information from the UCF in response to the request. The network device also includes circuitry configured to send a DL PDU to a RAN node based on the WTRU context information. In some implementations, the network device also includes circuitry which implements a UPF, and the indication that paging is required comprises downlink data. In some implementations, the indication that paging is required comprises downlink data received for a PDU session with a WTRU that is in an idle mode or an inactive mode. In some implementations, the network device also includes circuitry which implements a LMF or a NWDAF, and the indication that paging is required comprises a requirement for an updated location of the WTRU or a requirement that new data be collected from the WTRU.

In some implementations, the request for WTRU context information indicates a cause for the request for WTRU context information, a WTRU identifier, and/or a session identifier. In some implementations, the WTRU context information indicates likely WTRU locations in order from most likely location to least likely location. In some implementations, the WTRU context information indicates WTRU identifier information, CM state information, RM state information, WTRU registration area information, WTRU most recent location information, WTRU most likely location information, RAN node identifier information, paging timing information, WTRU radio capability information, and/or paging restriction information. In some implementations, the network device also includes circuitry which can trigger the RAN node to initiate paging based on the context information prior to sending a DL PDU to a RAN node. In some implementations, the network device also includes circuitry which implements a network function. In some implementations, the network function includes a UPF, SMSF, LMF, and/or AIML.

The following acronyms are used herein:
6GS 6G System
AF Application Function
AMF Access and Mobility Management Function
CM Connection Management
LMF Location Management Function
NAS Non-access Stratum
NEF Network Exposure Function
NF Network Function
NWDAF Network Data Analytics Function
PCF Policy Control Function
UCF UE Context Management Function
UDM Unified Data Management
UPF User Plane Function
RM Registration Management
SMF Session Management Function
TRF Tracking and Reachability Function

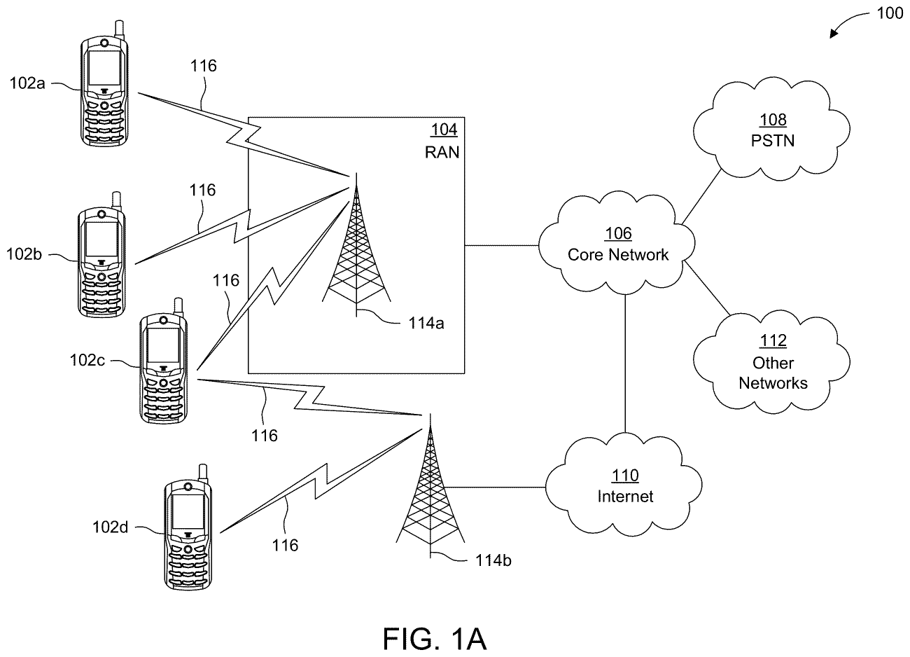

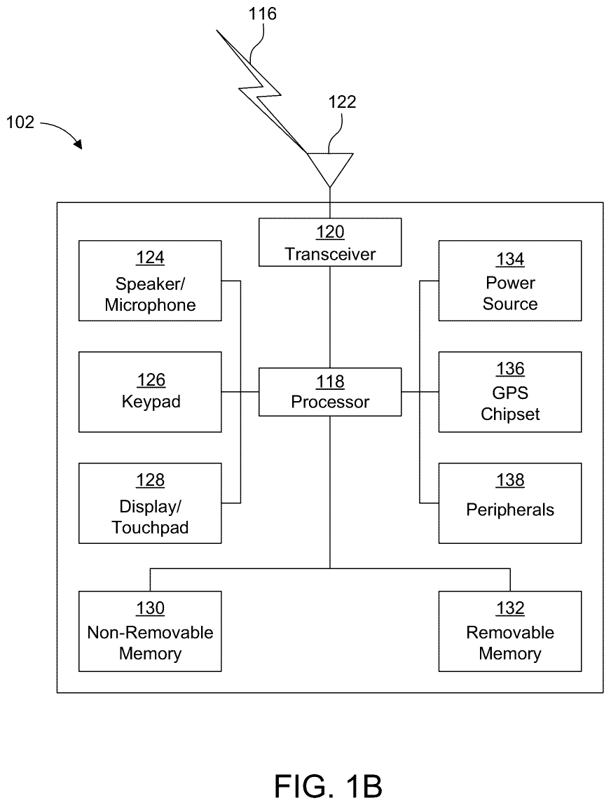

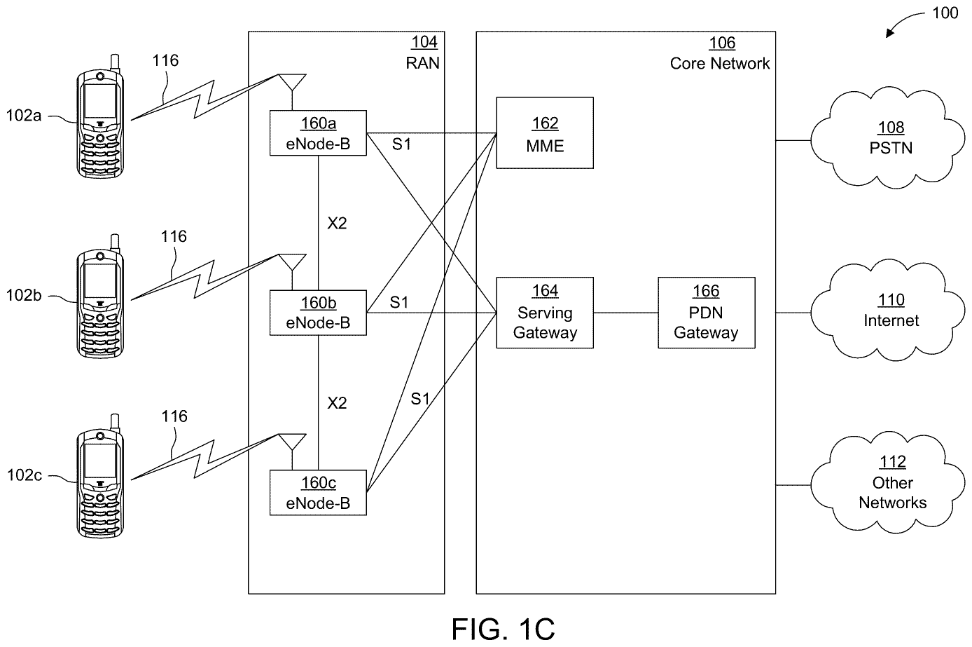

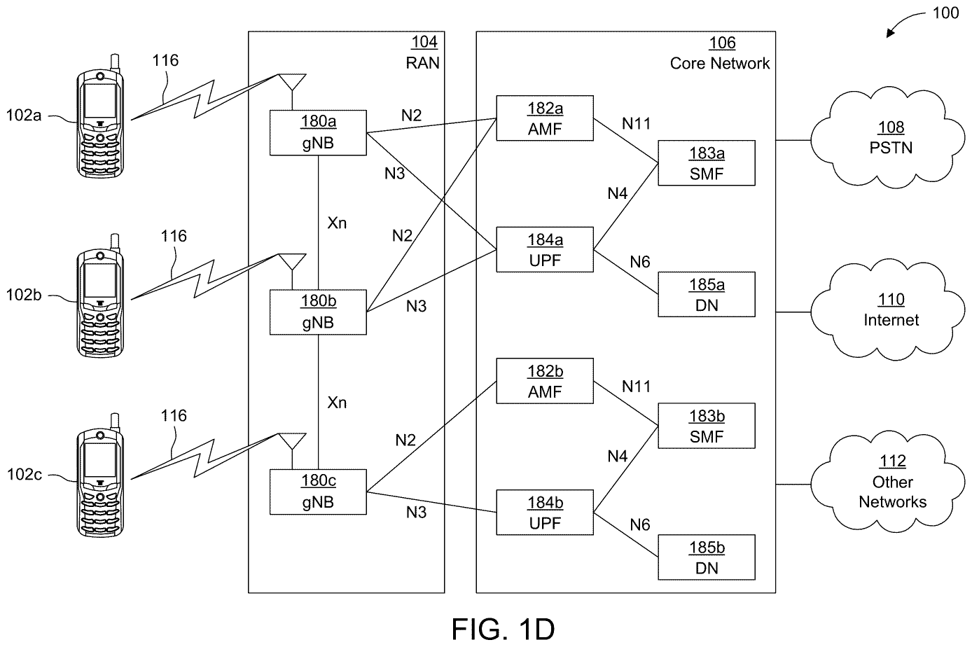

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80×80 configuration. For the 80×80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80×80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Example solutions discussed herein assume that any NF (e.g., UPF, SMF, PCF, AMF, NWDAF, LMF etc.) may identify that a WTRU needs to be paged for a service (e.g., DL data arrives, AI/ML data needs to be collected, location update required etc.), and may trigger a paging request towards one or more RAN nodes, however, UPF is used as an example NF for illustration.

In some example solutions, it is assumed that a WTRU to be paged is registered, but in CM_IDLE mode, that UCF is the managing entity for the context information of the WTRU in the network, where the UCF receives input from the WTRU, RAN, and other NFs, and the UCF constructs, stores and/or updates the WTRU context. Example parameters stored in the UCF for the WTRU context are discussed in further detail herein.

In some example solutions, a NF may perform the following actions. The NF may identify that paging is required (e.g., the NF has received DL data for the WTRU, has received a request to collect AIML data from the WTRU, or any other service request, and that the WTRU is identified to be in CM_IDLE. In some implementations, the NF may determine that the WTRU is in the CM_IDLE state based on the state of a tunnel between the NF and a RAN node, or based on the absence of a tunnel, associated with the WTRU, between the NF and a RAN node. In some implementations, based on the reception of DL data (e.g., a DL PDU) to be sent to the WTRU and the determination that the WTRU is in a CM_IDLE state, the NF may determine that the WTRU should be paged.

In a first example solution for identifying RAN nodes that are most relevant to the WTRU to be paged, the NF May send a request to the UCF to request WTRU context information, where the request may include WTRU identifier, session identifier, indication/cause for the request etc. The NF may receive a response from the UCF that includes the WTRU context information, where the WTRU context may include some or all the information as stored, e.g., Relevant RAN nodes IDs (IP address/FQDN) determined based on the WTRU most recent location and/or the most likely location or WTRU most recent location. Based on the WTRU context information received above, the NF may determine the most likely RAN-node(s) in priority order, where the WTRU may be located, may select one or a subset of the RAN-nodes as relevant, and may determine RAN node group identifiers to expand the search if the WTRU cannot be located with initial selection of the RAN nodes. The NF may send, the DL PDU and information to assist with a paging procedure to a RAN Node (e.g., the most relevant RAN node). Such assistance information be or include some or all of the parameters received in a context response received by NF (e.g., as described herein). The DL PDU may be sent to the RAN-Node in a GTP-U message and the header of the GTP-U message may include the information to assist with a paging procedure. The NF may receive a paging response that indicates that RAN is attempting to reach WTRU.

In a second example solution for identifying RAN nodes that are most relevant to the WTRU to be paged, the NF may determine the last known RAN node, e.g., when WTRU is CM-IDLE, the N3 tunnel is deactivated but if the information is still stored in the UPF for some time, the last serving RAN node information can be retrieved. The NF may send a paging request to that RAN node, which then coordinates with the UCF to get the WTRU context and other related information, e.g., WTRU location, to determine where to page.

In some example solutions, a RAN node may perform the following actions.

The RAN node may receive a paging request. The paging request message may include some or all of the parameters received in a context response received by NF (e.g., as described herein). Such parameters may include, e.g., a last known location of the WTRU, RAN node group info, and/or parameters of the corresponding flow (e.g., PPI, 5QI/6QI, ARP).

The RAN node may act as the main controlling entity for paging strategy determination and decisions, e.g., based on the received parameters. For example, in some implementations, the RAN node may determine the WTRU's reachability, the WTRU's paging priority, and/or whether RAN is enabled for paging policy differentiation. In this context, reachability refers to the ability of the network to reach the WTRU (i.e., network is able to locate and communicate with the WTRU). In some implementations, the RAN node may apply different paging strategies for different traffic or service types provided within the same PDU Session, e.g., based on the paging strategy determination and/or decisions.

In some implementations, if the WTRU is in a CM-IDLE state and the RAN is capable of paging the WTRU, the RAN may send a paging response (e.g., Nran_Paging) to the UPF (e.g., immediately) to indicate to the UPF that RAN is attempting to reach the WTRU.

In some implementations, if the RAN determines that the WTRU is not reachable for paging, the RAN may send a paging response to the UPF indicating that the WTRU is not reachable.

In some implementations, if the WTRU is in idle mode, it is assumed to be in the notification area of the RAN, if the WTRU changes RAN notification areas, then the last serving RAN node will be notified that the WTRU is no longer in its notification area. In such cases, the RAN node from whose area the WTRU has departed may completely remove any context saved locally.

In some implementations, if the RAN node needs more information about the WTRU to perform paging (e.g., the WTRU cannot be found), then the RAN node may send a WTRU context request to the UCF to determine WTRU context information from the UCF (e.g., last known WTRU location or most likely WTRU location, registration area information, list of relevant RAN nodes, etc.)

In some implementations the RAN may determine which RAN nodes to page based on the WTRU location information received in the WTRU context response. In some implementations, the WTRU location information includes WTRU location information in order from most likely location to least likely location. In some implementations, the RAN may determine an initial subset of RAN nodes to page, from within the RAN group, based on the most likely location.

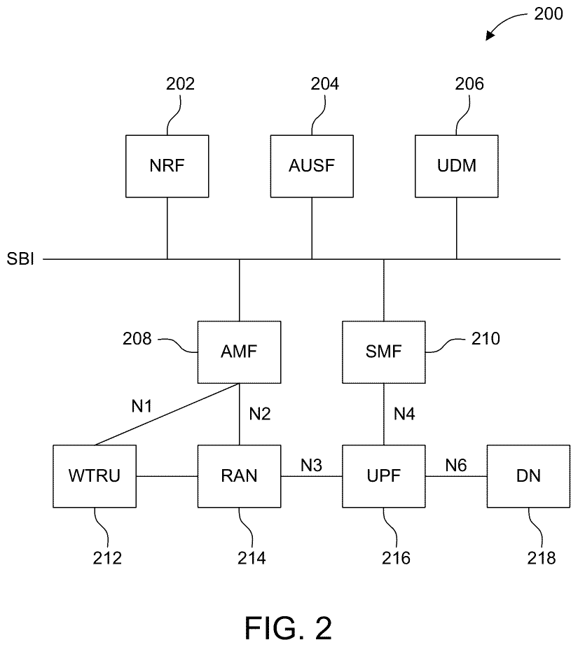

FIG. 2 is a block diagram which illustrates a simplified version of the 5G System Architecture 200, where only a subset of the NFs in the 5G Core are represented. Architecture 200 includes network repository function (NRF) 202, authentication server function (AUSF) 204, UDM 206, AMF 208, SMF 210, WTRU 212, RAN 214, UPF 216, and DN 218. The entities are in communication via several interfaces, including SBI, N1, N2, N3, N4, and N6 interfaces, as shown. WTRU 212 is or includes a WTRU in some implementations.

In some implementations, NFs (e.g., UDM 206, AMF 208, SMF 210) communicate with each other using a Service Based Interface (SBI) (e.g., using protocols such as hypertext transfer protocol (HTTP)). In some implementations, Service Based Architecture (SBA) enables NFs to expose services (e.g., using representational state transfer based (RESTful) application programming interfaces (APIs)) to other NFs, e.g., for the system to provide desired functionality. Other interfaces shown (Nx) in FIG. 2 and described below are different from SBI.

WTRU 212 communicates with AMF 208 over N1 using a NAS protocol. Control plane messaging between the WTRU 212 and other NFs (e.g., SMF 210) may be via a NAS transport encapsulation mechanism, e.g., provided by AMF 208 for the NFs.

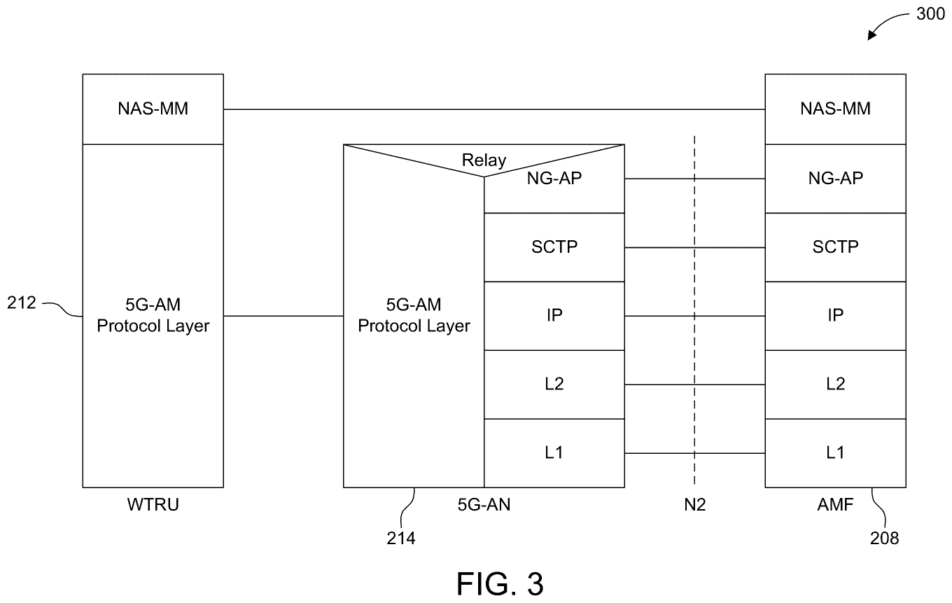

FIG. 3 is a block diagram which shows an example control plane stack 300 which illustrates interfaces between WTRU 212 and AMF 208. As illustrated in FIG. 3, RAN 214 (shown as 5G-AN in FIG. 3, communicates with AMF 208 over N2 using an NG-AP protocol. Control plane messaging between WTRU 212 and RAN 214 (Access Stratum (AS)) is via RRC and N1 is used to transport NAS messages from the network (AMF 208) to the WTRU 212.

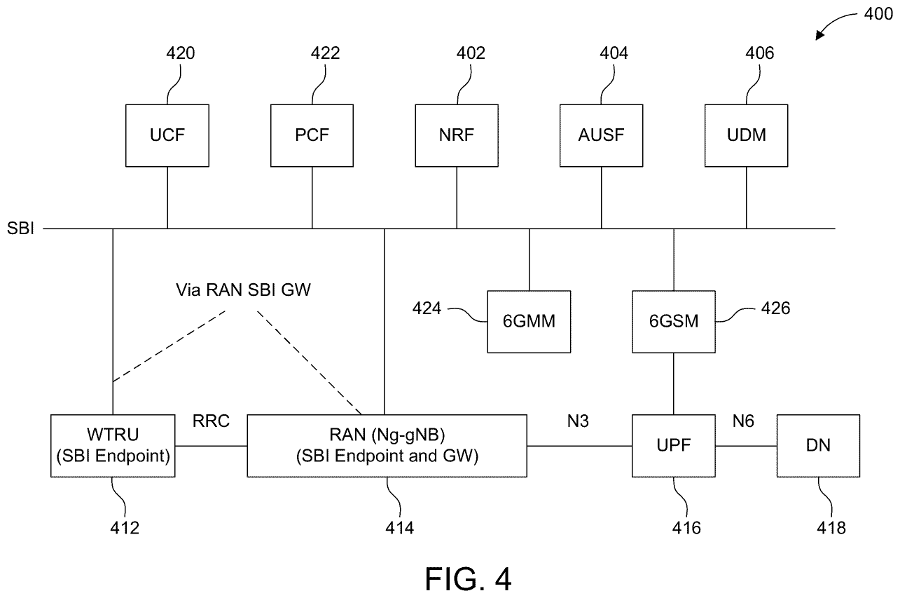

FIG. 4 is a block diagram which illustrates a simplified version of an example next generation Network Architecture 400, where only a subset of the NFs are represented. Architecture 400 includes UCF 420, PCF 422, NRF 402, AUSF 404, UDM 406, 6G mobility management function (6GMM) 424, 6G session management function (6GSM) 426, UE 412, RAN 414, UPF 416, and DN 418. In architecture 400, RAN 414 is a gateway to the SBI. The entities are in communication via several interfaces, including SBI, as shown. UE 412 is or includes a WTRU in some implementations.

The Next Generation Network architecture (i.e., beyond 5G) is expected to extend SBA concepts to the RAN, to simplify the network architecture while taking advantage of cloud native and micro-services technology to enhance architecture capabilities such as scalability, elasticity, and open interfaces.

Some implementations may extend the SBI framework beyond the 5GC NFs (e.g., as shown in FIG. 4). For example, in some implementations, a WTRU may use an evolved NAS mechanism to exchange NAS application messages directly with one or more NFs. As an example, in some implementations, an SBI compliant WTRU may establish an NAS application layer communication directly with an NF (e.g., SMF) without going through AMF (i.e., enhancing the N1 reference point to offer NAS application services over an SBI).

In some implementations, the next generation network may facilitate “connected intelligence” where intelligent networks using AIML technology connect a multitude of “intelligent” things. With data collection from a multitude of devices (e.g., sensors, Ambient IoT) and with the added flexibility and adaptability of AIML enabled functionalities, some implementations facilitate new advanced applications such as XR/Metaverse.

Some implementations include new functionality, e.g., in UCF 420, PCF 422, 6GMM 424, 6GSM 426, and/or RAN 414, as shown and described with respect to FIG. 4.

For example, in some implementations, RAN 414 node (which may be referred to as Ng-gNB) supports SBI towards the next generation Core Network (which may be referred to as 6GC). In some implementations, the Ng-gNB directly invokes services needed according to a procedure being performed with the WTRU 412. In some implementations, the N2 interface between the gNB and AMF in the 5G architecture is replaced by an SBI interface from the Ng-gNB to the 6GC (N2 interface from the 5GS), whereby Ng-gNB may invoke services provided by the 6GC over the SBI interface with any of the NFs.

In some implementations, after the UE 412 is successfully identified and authenticated, the Ng-gNB (RAN 414) may invoke services provided by the 6G NFs, e.g. for registration and mobility management via 6GMM 424 and/or session management (e.g., establishment, modification and release of PDU sessions) via 6GSM 426.

In some implementations, the Ng-gNB (RAN 414) invokes the service of a 6GMM 424 for access control or mobility updates of UE 412. In some implementations, the Ng-gNB (RAN 414) invokes the 6GSM 426 for session management service. In some implementations, the 6GSM 426 is or includes an evolved version of the 5G SMF to support direct interaction with Ng-gNB (RAN 414) for actions such as user plane resource allocation, AN-CN tunnel establishment. In this context, the AN-CN tunnel refers to the tunnel established between the Access Network (AN) and the Core Network (CN), particularly between RAN node 414 and UPF 416. The AN-CN tunnel uses an N3 interface that connects the gNB (AN) (RAN 414) to the UPF 416 (CN), and uses GTP-U tunneling protocol over N3. In some implementations, direct communication between the Ng-gNB (RAN 414) and 6GSM 426 allows for a reduction of signaling overhead due to messaging with intermediate NFs (e.g., AMF) as compared with 5G.

Similarly, in some implementations, the Ng-gNB (RAN 414) can invoke the service of UCF 420. In some implementations, UCF 420 acts as a “representative” of the UE 412 in the 6G CN. As such, in some implementations, UCF 420 maintains stateful information (e.g., all stateful information) related to the UE 412, such as registration or connection states, location, security context (e.g., material for SBI level security and AS security), subscription data from UDM etc. In some implementations, as the holder of security keys, UCF 420 provides a distribution service to RAN 414 for AS security establishment and (optionally) end-to-end SBI message security processing (between UE 412 and CN, over N3 between RAN 414 and UPF 416 as discussed above). In some implementations, UCF 420 behavior may include one or more of WTRU Context management (general) and/or WTRU Security Context management (general). Here, general refers e.g., to overall WTRU context details in contrast with service-oriented context information relevant to a particular service. WTRU Context management (general) behavior may include one or more of: creating the WTRU context during a new initial registration; generating and/or providing a WTRU temp ID upon WTRU context creation or update request; storing and/or maintaining WTRU subscription data, location info, connection/registration state, WTRU session context info (e.g., PDU Session Id, DNN, S-NSSAI, 5QI); and/or checking authorization for network service against WTRU Context (subscription data). WTRU Security Context management (general) may include one or more of: storing WTRU network access security material; generating and/or storing an AS session key for RAN; and/or processing the security of e2e secure SBI message (e.g., encrypt or decrypt).

In 5G mobile networks, in some implementations, paging allows a network to reach a WTRU when WTRU is not in an active communication state (e.g., in RRC-IDLE or RRC-INACTIVE). In the RRC-IDLE state, the WTRU is not connected to a gNB, and is monitoring only control channels of a configured cell. In the RRC-INACTIVE state, the WTRU retains context in both WTRU and gNB, but no active radio bearers.

In some implementations, paging is necessary when the network needs to establish communication with the WTRU. For example, in some implementations the network may need to establish communication with the WTRU when the network has DL data to deliver to a WTRU in an idle/inactive state, there is incoming voice call or IMS registration, for the network-initiated NAS signaling, e.g., location update, configuration, mobility management procedures, e.g., tracking area update etc. However, in some implementations, paging may not be needed when WTRU is in the RRC-CONNECTED state and CM-CONNECTED and/or CM-IDLE state.

In the 5GS paging process, in some implementations, after downlink data arrives at the User Plane Function (UPF) for a WTRU that is in CM-IDLE state (i.e., no active N3 user plane connection), the UPF may trigger a Downlink Data Notification (DLDN) to the Session Management Function (SMF). The SMF then initiates an N1N2 Message Transfer procedure toward the AMF via the N11 interface. Based on receiving this, the AMF may generate a NAS Paging message, encapsulate it in an NGAP Paging message, and forward it to the relevant gNB (or gNBs), which afterward broadcasts an RRC Paging message over the PCCH.

Paging in 5GS may follow several steps. For example, in a first 5GS paging step, in some implementations, paging may be initiated when the network needs to reach a WTRU in idle state. Paging is typically initiated by a core network component or Network Function such as the User Plane Function (UPF), Access and Mobility Function (AMF), Session Management Function (SMF), Policy Control Function (PCF), Unified Data Management (UDM) entity, or Location Management Function (LMF), e.g., depending on the nature of the data (e.g., control information or data). In some implementations, a paging request or message may be formed and may include information such as a WTRU identifier (e.g., TMSI or IMSI) and/or an event type (e.g., incoming call, SMS, data, etc.), and may include parameters used by the Access Node to execute its paging strategy, (e.g., 5QI and ARP). In this context, paging strategy refers to when and/or how to page the WTRU, e.g., in the CM-IDLE state. In some implementations, the aim of the paging strategy is to determine an optimal (or relatively best) way to locate the WTRU, and to reach the WTRU with minimal signaling (e.g., as low as possible). Example determinations and related decisions contributing to paging strategy include determining information indicating paging cause, determining paging area, determining DRX alignment for low power consumption (e.g., allowing the WTRU to wake-up occasionally), etc.

In a second 5GS paging step, in some implementations, a paging message is sent to an Access Network (AN) that broadcasts the paging signaling. The Access Network (or networks) (AN) may be associated with one or more gNBs, and may be determined based on a last known location or Tracking Area (TA) of the WTRU to be paged, e.g., as determined based on a paging strategy. In some implementations, the AN(s) and gNB(s) for performing paging broadcast signaling are determined in a balanced manner due to the limited nature of paging resources in a network and at a gNB. For example, in an unbalanced paging approach, broadcasting paging signaling over all gNBs (e.g., simultaneously) may waste network paging resources but provide high odds of successful paging with relatively shorter delays in reaching a WTRU. In a second example of an unbalanced paging approach, broadcasting paging signaling one gNB at a time may preserve network paging resources, but may provide low odds of successful paging, and/or relatively longer delays in reaching a WTRU. Accordingly, in some implementations, a balanced approach balances odds of successful paging, delay time in reaching a WTRU, and network paging resources by balancing paging signaling over a suitable number of gNBs.

In a third 5GS paging step, in some implementations, a WTRU in idle mode monitors the designated paging channel of the gNB where it is camped. If a paging message is received, the WTRU determines whether the paging message is intended for it. In some implementations, the WTRU responds to the paging message if the paging message is intended for it. In some implementations, the WTRU responds with a response message, which may be a NAS Service Request message, and which may indicate WTRU readiness to establish communication.

In a fourth 5GS paging step, in some implementations, AMF receives the Service Request Message, which may trigger procedures to establish the communication session.

Paging a WTRU in 5GS may face limitations and challenges. For example, 5GS WTRU paging my face limitations in terms of paging resources, paging latency, paging power consumption, paging efficiency, and/or paging scalability.

Paging resources relate to paging channel capabilities of the network. In some implementations, paging messages are broadcast over the network, and paging resources are limited. Accordingly, efficient management of the paging traffic may be needed in order to avoid congestion.

Paging latency relates to the time between the paging initiation at the core network (e.g., the first paging step discussed above) and the establishment of communication with the WTRU (e.g., the fourth paging step discussed above). The paging decisions or algorithm (e.g., the second paging step discussed above) may directly influence paging latency, which in turn may influence how quickly the user is informed of incoming communications and user experience.

Paging power consumption relates to the battery (or other) power that is needed to analyze paging traffic received at the WTRU. For example, a WTRU may be in idle mode to preserve power, but may still need to monitor paging messages sent on the paging channel of the gNB where it is camped. The frequency of paging occasions where paging is sent on the paging channel may influence WTRU battery life (or other power consumption) e.g., due to the required frequency of triggering of processing mechanisms in the WTRU to analyze the paging messages.

Paging efficiency relates to the odds of reaching a WTRU when paging. For example, if a WTRU in idle mode is in a poor coverage area, or if a WTRU moves out of a tracking area where the initial paging attempt took place thereby causing a subsequent attempt extending the paging area, the paging efficiency may decrease. This may result in greater latency in reaching a WTRU and/or higher consumption of network paging resources.

Paging scalability relates to the capability of the network to handle a high volume of WTRUs and/or a high volume of paging messages. For example, if congestion occurs on the paging channel, it may become impossible or inefficient to page a WTRU. This may result in missed calls, data session timeout, and/or poor user experience.

WTRU location tracking may be used to balance network constraints and user experience. For example, as discussed, the WTRU paging process involves consumption of limited network resources (e.g., the paging channel) and impacts the WTRU and user in various ways (e.g., battery life, latency, user experience). Accordingly, it may be desired to configure the WTRU paging process in such a way as to balance between network constraints and user experience.

In some implementations, to achieve a suitable balance between network constraints and user experience, the WTRU paging process may rely on WTRU location tracking information. For example, in some implementations, the network may be capable of achieving a good balance between network constraints and user experience if the WTRU location tracking information available in the network is accurate and precise.

WTRU location tracking capabilities may be leveraged in order to balance network constraints and user experience. For example, the 5G network is divided into multiple Tracking Areas (TA). Each TA may include a set of cells. A cell, or a gNB, is typically assigned and/or configured to broadcast in a single TA. In some implementations, WTRU location is tracked based on the current WTRU TA. IN some implementations, if a WTRU moves from one TA to another TA, a WTRU location update is triggered to inform the core network of the new WTRU location.

In the 5G network, in some implementations, the Access and Mobility Function (AMF) is responsible for managing WTRU mobility and tracking via WTRU registration, WTRU session management, and WTRU location updates. In some implementations, the AMF is informed if a WTRU moves to a different TA. This information may be used by the network when paging a WTRU for incoming calls and/or data. In some implementations, a 5G WTRU sends a registration request to the network to inform the AMF of its current location periodically, or upon leaving a registration area.

In the current 5GS, the AMF serves as a single termination point for Non-Access Stratum (NAS) signaling between the WTRU and the 5GC, including WTRU communication with other NFs. This tight coupling between the AMF and various NFs may prevent independent scaling of the various services offered by the network (e.g., AMF vs the other NFs) as the AMF may become a centralized bottleneck. An overload at the AMF, e.g., due to mobility management and/or other signaling events, may hinder the availability of the AMF to provide timely access (e.g., authentication) to new WTRUs.

To solve such issues, in some implementations, a distributed NAS-based architecture may be used to improve modularity, scalability and/or flexibility in next generation network design. However, in some implementations, the current paging procedure may not be adequate to support such distributed NAS-based architecture.

It is noted that current paging procedures include duplicated functionality in 5GS. For example, if a WTRU is in the CM-IDLE state the AMF performs paging and determines the paging strategy, whereas in if the WTRU is in the CM-CONNECTED state and the RRC-INACTIVE state, the NG-RAN performs paging and determines the paging strategy. Similarly, in the case of Network Triggered Service Requests from SMF, the SMF determines the 5QI and ARP based on the downlink packet and includes the 5QI and ARP in the paging request sent to the AMF. However, if the WTRU is in the CM-IDLE state, the AMF uses, e.g., the 5QI and ARP as received from the SMF to derive different paging strategies. Accordingly, it may be desired to remove duplication and establish more simplified procedures in next generation systems.

Such multi-step dependency on AMF during the paging procedure adds complexity, signaling overhead and potentially added latency (e.g., between the time a first DL packet is received by UPF to the time it is delivered to the WTRU). Furthermore, in the current architecture, intricate WTRU state management and paging logic realized in the AMF may present challenges for decoupling and/or streamlining paging in the Core Network (e.g., for reducing paging functionality duplication between the CN and RAN described above). For example, AMF maintains WTRU context information, including tracking their state (Idle or Inactive states), managing their registration area details (where the WTRU is registered and potentially located), and/or determination of paging strategy for WTRU in CM-IDLE.

Accordingly it may be desired to provide enhancements for a next generation mobile system in order to facilitate a more streamlined and efficient WTRU paging procedure, while considering, how to enable paging for distributed NAS in 6GS, how to reduce signaling overhead for a paging procedure, and/or how to remove redundancy or duplication in paging functionality, (e.g., between RAN and the core-network).

Various example methods, apparatuses, and systems are described herein to enhance the paging procedure for next generation wireless systems. For example, some implementations provide enhancements to the architecture which remove duplication of paging-related functionalities between the RAN and the core network, e.g., as present in current 5GS systems. In some implementations, the proposed mechanisms have the advantage of simplifying the paging procedure and/or providing performance improvements during WTRU paging. Some implementations provide the advantage of decoupling the paging procedure from AMF, leveraging RAN acting as a SBI gateway between a WTRU and the core network (CN).

In one example, a solution is proposed for RAN controlled paging, where core network functions (NFs; e.g., UPF, LMF), identify the most appropriate RAN nodes for paging based on the WTRU location. In some implementations, the NF provides necessary parameters for the RAN controlled paging, e.g., along with the paging request, to the RAN nodes. In some implementations, the RAN determines a paging strategy and makes paging decisions based on WTRU states (e.g., CM-IDLE, CM-INACTIVE, CM-CONNECTED) and received parameters.

In another example, a solution is proposed for RAN controlled paging, where core network functions (NFs; e.g., UPF, LMF), send paging requests to the last known RAN node based on the last known WTRU location. In some implementations, the last known RAN node may interact with the UCF to retrieve the context for paging (e.g., current location of the UE, tracking areas, and/or information regarding relevant RAN nodes).

The example solutions proposed below may provide RAN controlled paging. For example, in some implementations, in RAN controlled paging, the core network provides necessary details for the paging but is not involved in the paging strategy and paging decisions for any of the WTRU states (e.g., CM-IDLE, CM-CONNECTED). This contrasts with current paging procedures where the AMF performs paging and determines the paging strategy if the WTRU in CM-IDLE state, and the NG-RAN performs paging and determines the paging strategy if the WTRU is in CM-CONNECTED with RRC_INACTIVE state.

In some implementations, e.g., as described herein, paging related decisions (e.g., paging area determination, paging strategy determination and paging priority identification) are handled by the RAN (e.g., by a RAN node, such as a gNB). In some implementations, this avoids duplicated functionality, and may have the advantage of facilitating a relatively less complicated and more robust paging procedure.

For example, in some implementations, if a NF (e.g., UPF, PCF, SMF, NWDAF, LMF) identifies that a WTRU needs to be paged for any reason (e.g., the arrival of DL data, a need for AI/ML data collection, a need for WTRU location to be updated, etc.), the NF does not need to send a request to SMF and/or to AMF to trigger paging. In some implementations, an NF may trigger paging directly with the RAN node by sending a paging request message, and before sending the paging request the NF may retrieve WTRU context information from the UCF to determine which RAN node to contact. In some implementations, to avoid over-paging, a RAN node may deploy a paging strategy (e.g., not to page the WTRU for multiple paging requests from several different NFs, etc.)

In some implementations, solutions proposed herein may provide the advantage of facilitating simplified and/or more efficient paging procedures for a WTRU that is in CM-IDLE mode. In some implementations, this is done by allowing a direct connection between the RAN nodes and the NF that triggers paging request, and/or by allowing the NF to retrieve the WTRU context information from the UCF before sending a paging request to RAN. In some implementations, after the context information is retrieved, the NF may reuse this information to generate paging requests for the same WTRU for future instances, e.g., while the WTRU context information is valid.

An example system architecture baseline is used in the example embodiments illustrated herein. In the example system architecture, the core network enables distributed NAS functionality. In other words, the functionalities of some existing monolithic functions (e.g., AMF) may be broken down into more micro-service friendly dedicated functionalities, hosted by different network functions, and distributed across the core network.

Also in the example system architecture, the RAN node (which may be referred to as Ng-NB, Ng-gNB, or iNB) supports SBI towards the next generation Core Network, and acts as a SBI gateway between a WTRU and the core network (CN). In other words, in the example system architecture, the connection between RAN and all other NFs may be SBI based, without an N2 interface. Instead of N2, as in 5G RAN communications with other NFs via SMF. Except for UPF, where it has direct connection via N3. If RAN is service based, then N2 and N3 would not be needed. Such next generation RAN node may be referred to in any suitable manner. Some examples are “RAN node,” “Ng-gNB,” “next generation NB,” “next generation gNB”, “iNB”, “intelligent NB” and so forth. In some of the examples, Ng-gNB is used primarily for simplicity, and as a representative name of a next generation RAN node. In some implementations, a RAN node may receive WTRU context and may retain a copy for all the serving WTRUs. For the WTRUs that are not served by the RAN (e.g., those in CM-IDLE mode), the RAN node may request WTRU context information from the UCF.

Also in the example system architecture, a WTRU Context management function (UCF) may be implemented in the next generation Core Network. In some implementations, the UCF acts as a “representative” of the WTRU in the CN, and may maintain stateful information related to the WTRU, such as registration/connection states, location, security context (e.g., the key material for SBI level security and AS security), subscription data from UDM, and so forth. In some implementations, the context of the WTRU for a PDU session is managed by the UCF if the WTRU enters CM-IDLE state. In some implementations, the UCF may be implemented as an isolated NF, or may be hosted together or co-located with another NF that is commonly accessible by NFs serving the WTRU.

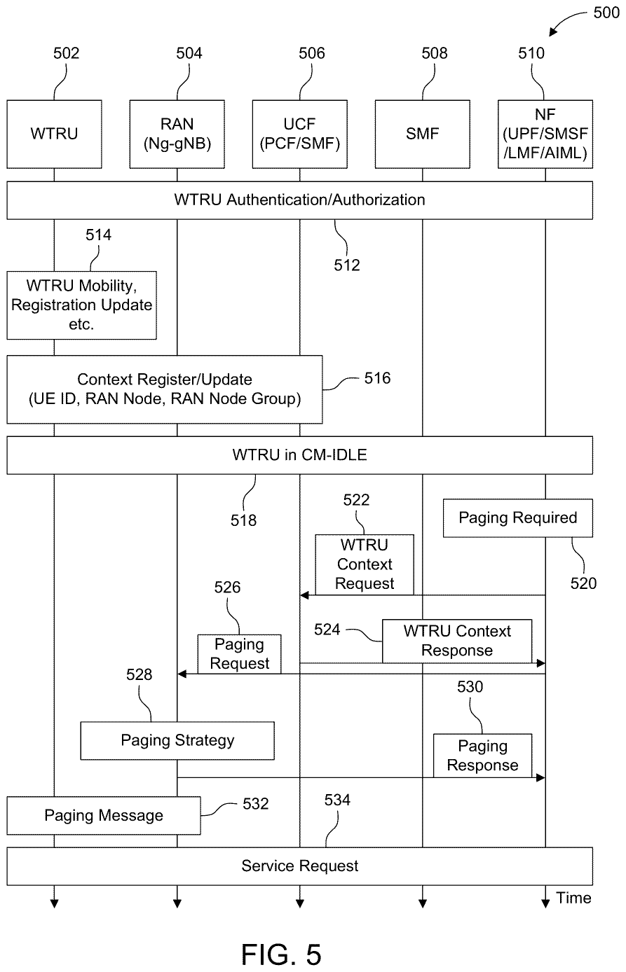

Some implementations include RAN controlled paging of a WTRU via most-relevant RAN node. For example, in some implementations, paging is RAN-controlled, where one or more core NFs (e.g., UPF, LMF) identify the most appropriate RAN node or nodes for paging a WTRU, based on the location of the WTRU. In some implementations, the NF (or NFs) provides details for the paging in the paging request to the RAN nodes. Example details for the paging include what is received from UCF in a context response. In some implementations, the RAN manages the paging strategy and paging decisions for the WTRU states (i.e. CM-IDLE, RRC idle, RRC active), based on the details for paging provided by the NF (e.g., as shown and described with respect to steps 516 and 520 in FIG. 5).

In this example system architecture, UPF is used as an example NF. In other implementations however, any suitable NF that determines a need to page the WTRU, e.g., for its respective functionality and requirements, may be used. Examples of other network functions include but are not limited to SMF, SMSF, Location Function, NWDAF, AMF and so forth.

FIG. 5 is a message sequence chart showing a procedure 500 which illustrates example RAN controlled paging. Procedure 500 illustrates example communications among WTRU 502, RAN 504 (a RAN node, such as a gNB), UCF 506, SMF 508, and NF 510.

Authentication of WTRU 502 takes place at 512, where WTRU 502 is successfully registered to access services over 6GS. Here, an RRC connection with Ng-gNB (RAN 504) is established, WTRU 502 is identified and authenticated, NAS registration procedure is complete, and WTRU 502 is assigned a registration area. After WTRU 502 is successfully registered, WTRU 502 may be required to perform a mobility registration update at 514 (e.g., due to a mobility, location or tracking area update). Whether it is initial registration or registration update due to mobility, WTRU context is created or updated, respectively. WTRU context store and/or update takes place at 516, where UCF 506 is the WTRU context managing entity for WTRU 502, which constructs, stores and/or updates the WTRU context. UCF 506 may receive WTRU specific context information from WTRU 502, from RAN 504 or from the other network functions.

Context information of WTRU 502 stored and/or updated in UCF 506 may include some or all of the following: one or more identifiers of WTRU 502 (e.g.,5G-GUTI/6G-GUTI, TMSI, SUPI); CM state of WTRU 502 (e.g., IDLE, CONNECTED); RM state of WTRU 502 (e.g., Registered, deregistered); Registration Area Information of WTRU 502 (e.g., which may include the set of TA where the WTRU is registered, the serving RAN nodes, or RAN node groups, and the last known cell info (if available), which may have associated RAN-notification area information); most recent location of WTRU 502 (which may be received by the UCF 506 from WTRU 502—e.g., each time WTRU 502 moves to a new location, WTRU 502 may update its location information in UCF 506 directly or via the location function); most likely location of WTRU 502 (which may be received from the NWDAF based on WTRU location history and/or WTRU profile); identifying information of RAN nodes that are relevant to WTRU 502 (e.g., RAN nodes that are serving the area where WTRU 502 is potentially located. In some implementations, such identification may include, e.g., IP address/FQDN information, e.g., determined based on the WTRU most recent location and/or most likely location; paging timing parameters (e.g., paging DRX settings, e.g., that would be beneficial for RAN node for paging decisions); information regarding a radio capability of WTRU 502 (e.g., information on RATs that WTRU 502 supports, power class, frequency bands, etc.); RAN 504 serving WTRU list update information (e.g., RAN 504 node may update its serving WTRU list in UCF 506 with RAN node group information); wakeup signal (WUS) assistance Information; and/or paging restriction information (e.g., access restrictions, slice-based paging restrictions, PLMN restrictions, RAI-based restrictions etc.).

In some implementations, during the NAS registration and mobility management procedures 514, e.g., registration/deregistration, mobility/periodic registration-update, service request procedures, in some implementations, the WTRU context may be created, updated, or deleted, in UCF 506 at 516.

In some implementations, e.g., during authentication at 512, UCF 506 may subscribe to receive input from the RAN nodes or the NFs (e.g., AMF, PCF, SMF). In some implementations, UCF 506 may also receive input directly from WTRU 502 once WTRU 502 is registered and data sessions are created between WTRU 502 and UCF 506.

In some implementations, e.g., during Context Registration and Update at 516, UCF 506 may be notified, e.g., by the AMF, when the RM state of WTRU 502 in the AMF transitions to RM-DEREGISTERED. In this case, UCF 506 may delete the locally stored context of WTRU 502 immediately, or may retain the locally stored context of WTRU 502 for some time while it updates the state of WTRU 502 to “deregistered”.

State change of WTRU 502 takes place at 518, to CM-IDLE. When the WTRU 502 is in CM-IDLE, WTRU 502 is not known to any of the NFs (NF 510) and no data session or control plane signaling is ongoing.

Paging is triggered at 520, where NF 510 determines that paging is required. In this example, paging is triggered by UPF (NF 510) receiving DL data for a PDU session (in other examples, paging may be triggered in other ways, by other NFs). After the UPF (NF 510) receives DL data and the AN-CN tunnel is no longer active (i.e., WTRU 502 is in CM-IDLE or CM-INACTIVE mode), the UPF (NF 510) may determine to page WTRU 502, and the UPF (NF 510) may begin to buffer downlink data.

The UPF (NF 510) sends a WTRU context request 522 (e.g., Nucf_UE_Context request) to UCF 506 to request WTRU 502 context information, after the UPF (NF 510) determines to page WTRU 502. WTRU context request 522 may include some or all the following: an indication or cause for the request (e.g., context for paging, e.g., that will help UCF to determine what parameters are requested); identifiers of WTRU 502 (e.g., SUPI); and/or session identifiers (e.g., PDU session ID, and type).

In example procedure 500, it is assumed that the CN (e.g., including UCF 506, SMF 508, NF 510) is not directly involved in the paging decisions itself but that information is available in the CN (e.g. WTRU context information stored in UCF 506). Such information may include, for example, the potential location of WTRU 502, associated tracking areas and RAN nodes that may help the UPF (NF 510) to determine which RAN node should be contacted for the paging request, and/or information indicating information to be provided to RAN 504 to facilitate determination by RAN 504 of the paging decisions and strategies. Accordingly, in some implementations, UPF (NF 510) requests such information from UCF 506 in WTRU context request 522.

The UPF (NF 510) receives WTRU context response 524 (e.g., Nucf_UE_Context response) from UCF 506. WTRU context response 524 may include some or all of the following: one or more identifiers of WTRU 502 (e.g.,5G-GUTI/6G-GUTI, TMSI, SUPI); CM state of WTRU 502 (e.g., IDLE, CONNECTED); RM state of WTRU 502 (e.g., Registered, deregistered); Registration Area Information of WTRU 502 (e.g., which may include the set of TA where the WTRU is registered, the serving RAN nodes, or RAN node groups, and the last known cell info (if available), which may have associated RAN-notification area information); most recent location of WTRU 502 (which may be received by the UCF 506 from WTRU 502—e.g., each time WTRU 502 moves to a new location, WTRU 502 may update its location information in UCF 506 directly or via the location function); most likely location of WTRU 502 (which may be received from the NWDAF based on WTRU location history and/or WTRU profile); identifying information of RAN nodes that are relevant to WTRU 502 (e.g., RAN nodes that are serving the area where WTRU 502 is potentially located. In some implementations, such identification may include, e.g., IP address/FQDN information, e.g., determined based on the WTRU most recent location and/or most likely location; paging timing parameters (e.g., paging DRX settings, e.g., that would be beneficial for RAN node for paging decisions); information regarding a radio capability of WTRU 502 (e.g., information on RATs that WTRU 502 supports, power class, frequency bands, etc.); RAN 504 serving WTRU list update information (e.g., RAN 504 node may update its serving WTRU list in UCF 506 with RAN node group information); wakeup signal (WUS) assistance Information; and/or paging restriction information (e.g., access restrictions, slice-based paging restrictions, PLMN restrictions, RAI-based restrictions etc.).

In some implementations, the WTRU location information may be based on network analytics (e.g., the most likely location of WTRU 502). In some such cases, UCF 506 may provide a Tracking Area List or RAN-nodes list, e.g., with a priority order from most likely location to the least likely location.

In some implementations, WTRU context request 522 and WTRU context response 524 can be skipped after the UPF (NF 510) has received the WTRU context information and it is still valid (e.g., an associated time and/or timer has not expired).

In some implementations, WTRU context request 522 and WTRU context response 524 may be replaced with a subscribe/notify message. For example, in some implementations the UPF (or any NF 510) may subscribe to UCF 506 or to the location management function (LMF) NF 510 for the WTRU location update. In other words, in some implementations, the UPF (NF 510) is notified when WTRU 502 changes its location. Accordingly, in some cases, whenever a DL PDU arrives at the UPF (NF 510), UPF (NF 510) knows the most recent location of WTRU 502 and may determine the relevant RAN-node based on the most recent location of WTRU 502. After the relevant RAN node is known (or nodes), the UPF (NF 510) may send the paging request 526 to the relevant RAN-node(s).

In one embodiment, the UPF (NF 510) may be notified, e.g., by the UCF, when the WTRU RM state in the AMF transitions to RM-DEREGISTERED, then the UPF (NF 510) may delete the locally stored WTRU context even if the timer has not expired.

Based on the WTRU context information received in WTRU context response 524, the UPF (NF 510) may determine the most likely RAN-node(s), in priority order, where the WTRU may be located; may select one or a subset of the RAN-nodes as relevant; and/or may determine RAN node group identifiers to expand the search if WTRU 502 cannot be located with initial selection of the RAN nodes.

UPF (NF 510) sends paging request 526 to RAN 504. In some implementations, paging request 526 is sent to RAN 504 based on the determination of the most likely RAN node or nodes. In some implementations, paging request 526 is or includes an Nran_Paging request. In some implementations, paging request 526 may include some or all of the parameters received in the WTRU context response 524. For example, in some implementations, paging request 526 may include, e.g., WTRU Registration Area Information, WTRU Identifiers, most up to date WTRU Radio Capability information, recent or most likely location of WTRU 502 and so forth.

In some implementations, the IP addresses or Fully Qualified Domain Name (FQDN) of the RAN node or nodes (e.g., RAN 504) and NFs (e.g., NF 510) are used to establish a connection between the RAN(s) and NF(s) over the SBI interface. If a data plane connection needs to be setup between the WTRU 502 and an NF 510, WTRU 502 must know the endpoint address of the NF 510 to send a data plane setup request to the CN.

In some implementations, the UPF (NF 510) may send paging request 526 to a selected subset of RAN nodes (e.g., including RAN 504) or it may send the request to all relevant RAN nodes. In some implementations, the RAN nodes to which paging request 526 is sent may be determined based on urgency requirements (e.g., based on the Differentiated Services Code Point (DSCP) in a TOS (IPv4)/TC (IPv6) value from the IP header of the DL PDU received by NF 510), and/or likelihood of where the WTRU located (e.g., if the WTRU has high likelihood to be in a certain location then only the most relevant RAN node(s) are contacted).

In some implementations, the UPF (NF 510) may include paging restriction information in paging request 526. In some implementations, the paging restriction information is used by RAN 504 to determine when it is restricted from paging a WTRU (e.g., WTRU 502). In some implementations, this has the advantage of reducing unnecessary network traffic.

In some implementations, UPF (NF 510) receives traffic filters and/or policies at session creation from the SMF in 512 when the PDU session is established. In some implementations, the traffic filters and/or policies are used to determine a corresponding QoS Flow, e.g., based on the QFI of the received DL PDU. In some implementations, UPF (NF 510) may determine a Paging Policy Indicator (PPI), e.g., based on a Differentiated Services Code Point (DSCP) (received in the header of the DL PDU) that indicates how to prioritize a packet. In some implementations, UPF (NF 510) may identify the 5QI/6QI (5G/6G QoS Identifier) and ARP (Allocation and Retention Priority) based on the DL PDU and Packet Detection Rules (PDRs) received at 512 from SMF 508 when the N4 tunnel was established during PDU session establishment.

In some implementations, UPF (NF 510) includes such parameters (e.g., PPI, 5QI/6QI, and/or ARP) of the corresponding flow in the paging request 526 sent to RAN 504. In some implementations, UPF (NF 510) may insert these parameters in an outer header of the outgoing PDU (from UPF NF 510 to RAN 504) or it may include these IEs in the paging request 526 with the associated DL PDU that is a part of paging request 526.

In some implementations, the UPF (NF 510) may determine not to send paging requests (e.g., if the UPF (NF 510) was notified earlier that WTRU 502 is unreachable, or that WTRU 502 is reachable only for regulatory or emergency services while the PDU session is not for regulatory or emergency services.

In some implementations, UPF (NF 510), while waiting for the N3 Tunnel to be activated (e.g., for a previous paging request), receives any additional data packets for a QoS Flow associated with a higher priority (i.e. ARP priority level) than the priority indicated to the RAN 504 in the previous Nran_Paging request, or the UPF(NF 510) derives a different Paging Policy Indicator according to an additional Data Notification (e.g., indicating that more information can be provided in the second paging request for the same WTRU 502) or the DSCP of the DL PDU, the UPF invokes a new paging request (e.g., Nran_Paging request) indicating the higher priority or different Paging Policy Indicator to the RAN.

RAN 504 determines the paging strategy at 528. In some implementations, if the WTRU 502 is in the CM_CONNECTED state, RAN 504 has information about WTRU 502 and knows how to locate WTRU 502. In this context, locate means to determine the most likely position of the WTRU 502. Since WTRU 502 is in idle mode, it is not actively communicating. Accordingly, in some implementations, the network makes a best guess to start paging in that area and then expands the search. In some implementations, if WTRU 502 is in the CM_IDLE state, RAN 504 relies on information provided by one or more NFs (e.g., NF 510), e.g., as received in paging request 526, to locate WTRU 502.

In some implementations, based on reception of the paging request 526 and/or information indicated by paging request 526 (e.g., WTRU IDs such as TMSI, GUTI, SUPI, the Registration Area List, Paging DRX parameters etc.), RAN 504 determines whether WTRU is in the RM-REGISTERED state, whether WTRU 402 is in the CM-IDLE state and whether WTRU 402 is reachable or unreachable in 3GPP access. RAN 504 determines paging priority and/or paging strategy (e.g., based on the state and reachability determination) and begins to page WTRU 502.

In some implementations, if extended idle mode DRX was accepted by the AMF in the last registration procedure, the AMF provides this information to the UCF 506 in step 516. In some implementations this information is stored in the WTRU context, and the WTRU context response 524 indicates the extended idle mode DRX cycle length and Paging Time Window, after which this information is provided to RAN 504 in the paging request 526 by the UPF (NF 510). Based on this information, RAN 504 ensures that the correct Paging DRX length is used when paging based on the accepted WTRU Specific DRX of the current RAT.

In the current 5GS, paging policy differentiation is a feature that allows the AMF, based on operator configuration, to apply different paging strategies for different traffic or service types provided within the same PDU Session. In some implementations, this functionality is implemented in the NG-RAN node (e.g., RAN 504). For example, in some implementations, the NG-RAN may apply different paging strategies for different types of traffic (e.g., based on operator configuration). In some implementations, the paging strategy may be configured locally on the RAN node (e.g., RAN 504), may be provided in the paging request (e.g., paging request 526), and/or or may be requested from a NF (e.g., NF 510), such as NWDAF. In some implementations, RAN 504 may use the 5QI/6QI, ARP and PPI (e.g., as received in paging request 526) to derive different paging strategies. In some implementations, different paging strategies may be configured in the RAN (e.g., RAN 504) for different combinations of DNN, Paging Policy Indicator (if supported), ARP and 5QI.

Based on the paging strategy determined at 528, RAN 504 sends a paging response 530 (e.g., a Nran_Paging response) to NF 510. In some implementations, if WTRU 502 is in the CM-IDLE state and RAN 504 is able to page WTRU 502, RAN 504 sends (e.g., immediately) paging response 530 to the UPF (NF 510) to indicate that RAN 504 is attempting to reach WTRU 502.

In some implementations, while waiting for WTRU 502 to respond to a previous paging request, if RAN 504 receives paging request 526 (e.g., an Nran_Paging Request message) with the same or a lower priority than the previous paging request message, or if RAN 504 has determined not to trigger additional paging requests for WTRU 502 based on local policy, the RAN rejects paging request message 526.

In some implementations, if WTRU 502 is in the CM-IDLE state and RAN 504 determines that WTRU 502 is not reachable for paging, RAN 504 may send paging response 530 to the UPF (NF 510) indicating WTRU 502 is not reachable. In some implementations this paging response may indicate to the UPF to stop sending data notifications for WTRU 502, to stop buffering DL data for WTRU 502, and/or to discard data buffered for WTRU 502. In some implementations this paging response may indicate to the UPF not to send paging requests while WTRU 502 is unreachable.

In some implementations, if RAN 504 detects that the WTRU context contains paging restriction information, RAN 504 may block paging for WTRU 502, based on local policy and the stored paging restriction information. If RAN 504 blocks paging, paging response 530 may include an indication with a cause that the paging request has been rejected due to restricted paging to the NF 510 (from which RAN 504 received the paging request message (e.g., UPF in this case).

In some implementations, if WTRU 502 is in idle mode, it is assumed to be in the notification area of RAN 504. If WTRU 502 changes the RAN notification area, then the last serving RAN node will be notified that WTRU 502 is no longer in the notification area. In that case, the RAN node (e.g., RAN 504) may completely remove any context saved locally.

In some implementations, if WTRU context of WTRU 502, including PDU session context, is stored in UCF 506, RAN 504 contacts UCF 506 to retrieve WTRU context, including PDU session context, and to reestablish the PDU session per request from WTRU 502.

RAN 504 sends paging message 532 to WTRU 502 based on paging request 526. In some implementations, if RAN 504 determines that WTRU 502 is in the RM-REGISTERED state, is in the CM-IDLE state, and is reachable in 3GPP access, RAN 504 initiates paging by sending paging message 532 to WTRU 502 based on paging request 526, based on the paging strategy 528, and/or based on paging priority.

WTRU 502 initiates a WTRU triggered service request procedure 534 based on paging message 532. In some implementations, WTRU 502 initiates WTRU triggered service request procedure 534 if WTRU 502 is in CM-IDLE state in 3GPP access, upon reception of a paging request for a PDU Session associated with 3GPP access (e.g., paging message 532).

In some implementations, based on receiving incoming DL data for a WTRU (e.g., WTRU 502) that has no active data connection (e.g., is in CM_IDLE state in UCF) UPF 506 may notify the serving SMF (e.g., SMF 508, e.g., via N4 interface), which then performs steps to initiate paging by RAN 504 with UCF assistance as described above.

In some implementations, based on receiving incoming SMS data for a WTRU (e.g., WTRU 502) that has no active signaling or data connection (e.g., is in CM_IDLE state in UCF), SMSF (NF 510) performs steps to initiate the paging by RAN 504 with UCF assistance as described above. In some implementations, the SMSF may indicate paging priority to RAN 504. In some implementations, after the WTRU responds with a service request, the SMSF is notified that WTRU 502 is ready to receive SMS data. In some implementations, the SMSF sends the SMS data to RAN 504, which forwards it to WTRU 502. In some implementations, RAN 504 forwards any SMS ACK from the WTRU 504 to the SMSF.

Some implementations include RAN controlled paging of a WTRU via a last-known RAN node. For example, in some implementations, paging is RAN-controlled, where a core network function (NF, e.g., UPF, LMF) sends a paging request to the last known RAN node based on the last known location of the WTRU to be paged, and the last known RAN node may interact with the UCF to retrieve the WTRU context used for paging (i.e., current location of the WTRU, tracking areas, and the information of relevant RAN nodes).

In some implementations, core network functions may send DL data towards the WTRU (e.g., regardless of the WTRU state) via the last known RAN node, and the last known RAN node determines whether paging is needed, determines where and how to page the WTRU on reception of the DL data, and/or determines the WTRU state. In some implementations, additional information that is needed from the core network by the last known RAN node may be included as part of the traffic (e.g., in GTP headers). In some implementations, a GTP tunnel may be deleted and/or terminated if the WTRU is in an idle state, and an always-active link may be maintained between the NF and RAN to provide this information to RAN.

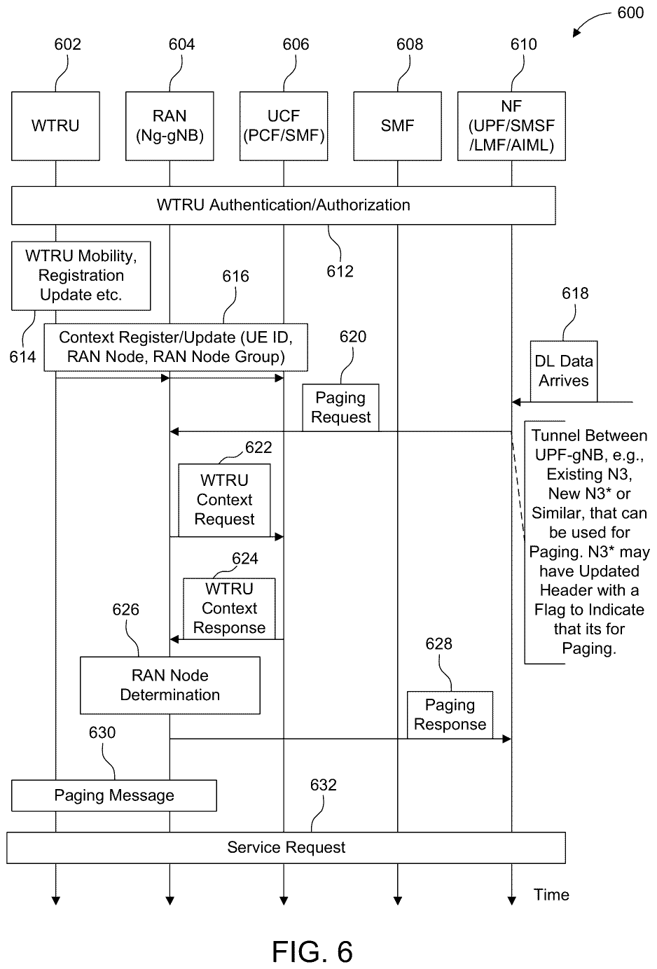

FIG. 6 is a message sequence chart showing a procedure 600 which illustrates example RAN controlled paging. Procedure 600 illustrates example communications among WTRU 602, RAN 604 (a RAN node, such as a gNB), UCF 606, SMF 608, and NF 610.

Authentication of WTRU 602 takes place at 612, where WTRU 602 is successfully registered to access services over 6GS. Here, an RRC connection with Ng-gNB (RAN 604) is established, WTRU 602 is identified and authenticated, NAS registration procedure is complete, and WTRU 602 is assigned a registration area. After WTRU 602 is successfully registered, WTRU 602 may be required to perform a mobility registration update at 614 (e.g., due to a mobility, location or tracking area update). WTRU context store and/or update takes place at 616, where UCF 606 is the WTRU context managing entity for WTRU 502, which constructs, stores and/or updates the WTRU context.

In the example procedure 600, it is assumed that UPF (NF 610) does not interact with the UCF 606 to retrieve the most recent location of WTRU 602, or other context information of WTRU 602 that is used for paging assistance.

The UPF (NF 610) sends a paging request 620 to RAN 604 based on the arrival of DL data 618. In some implementations, the UPF, may only contact the last known RAN node (e.g., RAN 604) to send the paging request 620, assuming that the last known RAN node information was stored in the UPF.

In some implementations, if AN-Tunnel Info is stored in the UPF when WTRU 602 is CM-IDLE, the N3 tunnel is deactivated but the last known RAN node information is still stored in the UPF for an amount of time (e.g., for a pre-defined amount of time), and the last known RAN node information can be retrieved based on the N3 tunnel even after WTRU 602 is no longer connected. In other words, in some implementations, if WTRU 602 becomes idle, the N3 tunnel is deactivated but the information remains stored in the UPF for some time, and the last serving RAN node information can be retrieved on this basis.

In some implementations, N3 tunnel management is updated to facilitate this behavior. For example, in some implementations, the header of paging request 620 includes a paging indication to indicate to RAN 604 not to discard paging request 620. In some implementations, this differs from current processes where a RAN node discards any message associated with the N3 tunnel if the WTR is in an idle or inactive state and the tunnel is not active.

In some implementations, a GTP-U header of a DL PDU may include a paging indication. For example, if such indication is included in a GTP-U header, the RAN node 604 may not discard the DL packet received even if the tunnel no longer exists. In some implementations, if RAN 604 manages the PDU session context, RAN 604 may be aware that the PDU session is in a deactivation state, and may page WTRU 602 to activate the inactive PDU session.

RAN 604 sends WTRU context request 622 to UCF 606, and receives WTRU context response 624 from UCF 606, based on paging request 620. In some implementations, these messages are similar to WTRU context request 522 and WTRU context response 524 as shown and described with respect to FIG. 5, except that it is RAN 604 that requests the WTRU context information from the UCF 606 (e.g., last known location of WTRU 602 or most likely location of WTRU 602, registration area information, list of relevant RAN node(s) etc). In some implementations, UCF 606 includes some or all of the following: one or more identifiers of WTRU 602 (e.g.,5G-GUTI/6G-GUTI, TMSI, SUPI); CM state of WTRU 602 (e.g., IDLE, CONNECTED); RM state of WTRU 602 (e.g., Registered, deregistered); Registration Area Information of WTRU 602 (e.g., which may include the set of TA where the WTRU is registered, the serving RAN nodes, or RAN node groups, and the last known cell info (if available), which may have associated RAN-notification area information); most recent location of WTRU 602 (which may be received by the UCF 606 from WTRU 602—e.g., each time WTRU 602 moves to a new location, WTRU 602 may update its location information in UCF 606 directly or via the location function); most likely location of WTRU 602 (which may be received from the NWDAF based on WTRU location history and/or WTRU profile); identifying information of RAN nodes that are relevant to WTRU 602 (e.g., IP address/FQDN) e.g., determined based on the WTRU most recent location and/or most likely location; paging timing parameters (e.g., paging DRX settings, e.g., that would be beneficial for RAN node for paging decisions); information regarding a radio capability of WTRU 602 (e.g., information on RATs that WTRU 602 supports, power class, frequency bands, etc.); RAN 604 serving WTRU list update information (e.g., RAN 604 node may update its serving WTRU list in UCF 606 with RAN node group information); wakeup signal (WUS) assistance Information; and/or paging restriction information (e.g., access restrictions, slice-based paging restrictions, PLMN restrictions, RAI-based restrictions etc.).

In some implementations where RAN 604 has subscribed to the UCF 606 for the WTRU 602, i.e. RAN 604 may be notified if the WTRU 602 location is updated or context is update then it may receive a notification so that RAN 604 may request updated context information, this step occurs when the N3 tunnel was established or successful registration procedure, in this scenarios wherein the RAN node has some context information stored locally, it will use that information and process the paging request, skipping the WTRU context request 622 and WTRU context response 624.

RAN 604 (which is the last-known RAN node) determines which other RAN nodes to page at 626. For example, in some implementations, RAN 604 determines which RAN nodes to page (e.g., a group of RAN nodes) based on the location information regarding WTRU 602 received in the WTRU context response 624. In some implementations, the location information regarding WTRU 602 received in the WTRU context response 624 indicates locations from most likely location to least likely location. In some implementations, RAN 604 determines to initially page a subset of RAN nodes, within the group of RAN nodes, that is associated with the most likely location. In some implementations, RAN 604 may contact one or more RAN nodes in that subset, and if WTRU 602 is not found within that subset, RAN 604 expands the search by contacting further RAN nodes (e.g., in order from most to least likely location) until it finds the WTRU 602.

Based on RAN node determination 626, RAN 604 sends paging response 628 to NF 610, sends paging message 630 to WTRU 602, and WTRU 602 initiates a WTRU triggered service request 632 based on paging message 630. Paging response 628, paging message 630, and WTRU triggered service request 632 are substantially similar to Paging response 530, paging message 532, and WTRU triggered service request 534 as shown and described with respect to FIG. 5.

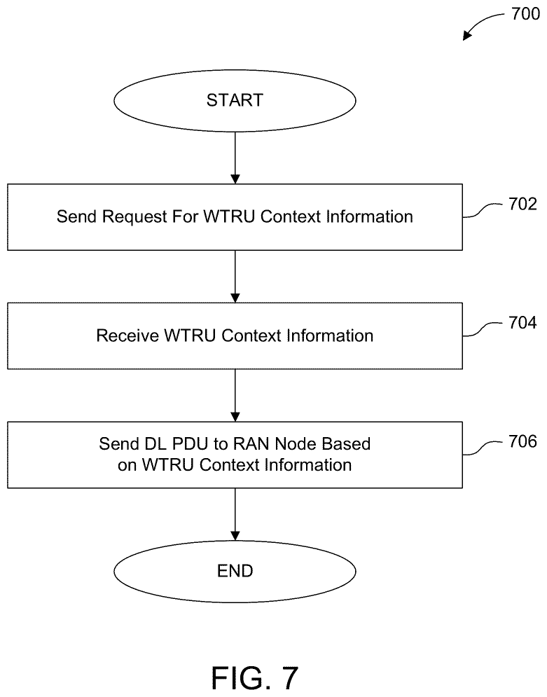

FIG. 7 is a flow chart illustrating an example method 700 for RAN controlled paging.

At 702, a request is sent for WTRU context information. In some implementations, the request is sent responsive to an indication that paging of the WTRU is required. In some implementations, the indication that paging of the WTRU is required includes the arrival of downlink data, a requirement for an updated location of the WTRU, a requirement that new data be collected from the WTRU, and/or any other suitable requirement, e.g., as discussed herein. In some implementations, the request is sent to a UCF. In some implementations, the request indicates a cause for the request for WTRU context information, a WTRU identifier, and/or a session identifier.

At 704, WTRU context information is received. In some implementations, the request is received from the UCF. In some implementations, the WTRU context information indicates WTRU identifier information, CM state information, RM state information, WTRU registration area information, WTRU most recent location information, WTRU most likely location information, RAN node identifier information, paging timing information, WTRU radio capability information, and/or paging restriction information. In some implementations, the WTRU context information indicates likely WTRU locations in order from most likely location to least likely location. In some implementations, the WTRU context information includes any other suitable context information, e.g., as discussed herein.

At 706, a DL PDU is sent to a RAN node based on the WTRU context information. In some implementations, the DL PDU is sent to the RAN node based on paging that is based on the WTRU context information.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method implemented in a network device, the method comprising:
responsive to an indication that paging is required, sending a request for wireless transmit/receive unit (WTRU) context information to a user equipment context function (UCF);
receiving the WTRU context information from the UCF in response to the request; and
sending a downlink (DL) protocol data unit (PDU) to a radio access network (RAN) node based on the WTRU context information.

2. The method of claim 1, wherein the network device implements a user plane function (UPF), and the indication that paging is required comprises downlink data.

3. The method of claim 1, wherein the indication that paging is required comprises downlink data received for a PDU session with a WTRU that is in an idle mode or an inactive mode.

4. The method of claim 1, wherein the network device implements a location management function (LMF) or a network data analytics function (NWDAF), and the indication that paging is required comprises a requirement for an updated location of the WTRU or a requirement that new data be collected from the WTRU.

5. The method of claim 1, wherein the request for WTRU context information indicates a cause for the request for WTRU context information, a WTRU identifier, and/or a session identifier.

6. The method of claim 1, wherein the WTRU context information indicates likely WTRU locations in order from most likely location to least likely location.

7. The method of claim 1, wherein the WTRU context information indicates WTRU identifier information, connected mode (CM) state information, registration mode (RM) state information, WTRU registration area information, WTRU most recent location information, WTRU most likely location information, RAN node identifier information, paging timing information, WTRU radio capability information, and/or paging restriction information.

8. The method of claim 1, further comprising triggering the RAN node to initiate paging based on the context information prior to sending a DL PDU to a RAN node.

9. The method of claim 1, wherein the network device implements a network function.

10. The method of claim 9, wherein the network function comprises a user plane function (UPF), short message service function (SMSF), location management function (LMF), and/or artificial intelligence/machine learning function (AIML).

11. A network device comprising:
circuitry configured to send a request for wireless transmit/receive unit (WTRU) context information to a user equipment context function (UCF), responsive to an indication that paging is required;
circuitry configured to receive the WTRU context information from the UCF in response to the request; and
circuitry configured to send a downlink (DL) protocol data unit (PDU) to a radio access network (RAN) node based on the WTRU context information.

12. The network device of claim 11, further comprising circuitry configured to implement user plane function (UPF), and the indication that paging is required comprises downlink data.

13. The network device of claim 11, wherein the indication that paging is required comprises downlink data received for a PDU session with a WTRU that is in an idle mode or an inactive mode.

14. The network device of claim 11, further comprising circuitry configured to implement a location management function (LMF) or a network data analytics function (NWDAF), and the indication that paging is required comprises a requirement for an updated location of the WTRU or a requirement that new data be collected from the WTRU.

15. The network device of claim 11, wherein the request for WTRU context information indicates a cause for the request for WTRU context information, a WTRU identifier, and/or a session identifier.

16. The network device of claim 11, wherein the WTRU context information indicates likely WTRU locations in order from most likely location to least likely location.

17. The network device of claim 11, wherein the WTRU context information indicates WTRU identifier information, connected mode (CM) state information, registration mode (RM) state information, WTRU registration area information, WTRU most recent location information, WTRU most likely location information, RAN node identifier information, paging timing information, WTRU radio capability information, and/or paging restriction information.

18. The network device of claim 11, further comprising further comprising circuitry configured to trigger the RAN node to initiate paging based on the context information prior to sending a DL PDU to a RAN node.

19. The network device of claim 11, further comprising circuitry configured to implement a network function.

20. The network device of claim 19, wherein the network function comprises a user plane function (UPF), short message service function (SMSF), location management function (LMF), and/or artificial intelligence/machine learning function (AIML).
